(19) United States
(12) Patent Application Publication
(10) Pub. No.: US 2023/0282042 A1
(43) Pub. Date: Sep. 7, 2023

(54) DIAGNOSIS APPARATUS

(71) Applicant: ISUZU MOTORS LIMITED, Tokyo (JP)

(72) Inventors: Toshiyuki USUI, Kanagawa (JP); Hironori ARAKI, Kanagawa (JP)

(21) Appl. No.: 18/019,091

(22) PCT Filed: Aug. 20, 2021
(86) PCT No.: PCT/JP2021/030611

§ 371 Date: Jan. 31, 2023

(30) Foreign Application Priority Data
Aug. 21, 2020 (JP) 2020-140039

(51) Int. Cl. G07C 5/08

(52) U.S. Cl. CPC G07C 5/0816; G07C 5/0808

(57) ABSTRACT

A diagnosis apparatus including: a first data acquisition part that acquires time series data from an apparatus to be diagnosed a first number of times every predetermined time period; a possibility determination part that determines whether there is a possibility of abnormality occurrence in the apparatus to be diagnosed during the predetermined time period on the basis of the time series data; a second data acquisition part that acquires the time series data a second number of times, which is greater than the first number of times, when it is determined that there is the possibility of abnormality occurrence; and an abnormality determination part that determines whether an abnormality has occurred in the apparatus to be diagnosed on the basis of changes in data indicated by the time series data acquired by the second data acquisition part.

### TECHNICAL FIELD

The present invention relates to a diagnosis apparatus for diagnosing a state of an apparatus to be diagnosed.

### BACKGROUND OF THE INVENTION

As an example of a diagnosis apparatus, there is a diagnosis apparatus that acquires, as time series data, various types of data accumulated during traveling of a vehicle and diagnoses a state of the vehicle (see Patent Document 1 below, for example). The diagnosis apparatus receives the time series data from a plurality of vehicles, serving as apparatuses to be diagnosed, in real time, and diagnoses the state of each vehicle.

### PRIOR ART

### Patent Document

Patent Document 1: Japanese Unexamined Patent Application Publication No. 2019-95878

### BRIEF DESCRIPTION OF THE INVENTION

### Problem to be Solved by the Invention

However, in a case where all of the time series data is received from the apparatuses to be diagnosed, the communication traffic becomes excessive, and the storage capacity of the time series data in the diagnosis apparatus becomes large, so that the processing load of the diagnosis apparatus is increased.

The present invention focuses on this point, and its object is to appropriately determine an occurrence of an abnormality in an apparatus to be diagnosed while suppressing the amount of time series data received.

### Means for Solving the Problem

In a first aspect of the present invention, it is provided a diagnosis apparatus for performing data communication with an apparatus to be diagnosed, which is a diagnosis target, the diagnosis apparatus including: a first data acquisition part that acquires time series data for diagnosis from the apparatus to be diagnosed every predetermined time period, the first data acquisition part acquiring the time series data a first number of times in each period; a possibility determination part that determines whether there is a possibility of abnormality occurrence in the apparatus to be diagnosed during the predetermined time period on the basis of the time series data acquired by the first data acquisition part; a second data acquisition part that acquires the time series data a second number of times, which is greater than the first number of times, when the possibility determination part determines that there is the possibility of abnormality occurrence in consecutive predetermined time periods; and an abnormality determination part that determines whether an abnormality has occurred in the apparatus to be diagnosed on the basis of changes in data indicated by the time series data acquired by the second data acquisition part.

The first data acquisition part may acquire the time series data the first number of times in a first period within the predetermined time period, and the second data acquisition part may acquire the time series data the second number of times in a second period which is longer than the first period.

The second data acquisition part may acquire the time series data the second number of times in the second period which is more than twice the first period.

The first data acquisition part may acquire the time series data the first number of times in a first period, which is a period shorter than half of the predetermined time period.

The first data acquisition part may acquire, as the time series data, data indicating an operation state of the apparatus to be diagnosed.

The possibility determination part may determine that there is the possibility of abnormality occurrence when an evaluation index exceeds a predetermined threshold, the evaluation index being a time integral of an excess amount of data that changes over time, in the time series data, the excess amount being an amount of data exceeding a predetermined amount from when the data exceeds the predetermined amount to when the data falls below the predetermined amount.

The abnormality determination part may determine that an abnormality has occurred in the apparatus to be diagnosed when the evaluation index of the time series data indicates an increasing tendency.

### Effect of the Invention

According to the present invention, it is possible to appropriately determine an occurrence of an abnormality in an apparatus to be diagnosed while suppressing the amount of time series data received.

### BRIEF DESCRIPTION OF THE DRAWINGS

FIG. 1 is a schematic diagram illustrating an outline of a diagnosis system 1.

FIG. 2 is a block diagram illustrating a configuration of a diagnosis apparatus 10.

FIG. 3 is a schematic diagram illustrating a period during which a first data acquisition part 162 acquires time series data.

FIG. 4 is a schematic diagram illustrating a period during which a second data acquisition part 164 acquires time series data.

FIG. 5 is a flowchart for illustrating an abnormality determination process for a vehicle 2.

### DESCRIPTION OF EMBODIMENTS

### <Configuration of a Diagnosis Apparatus>

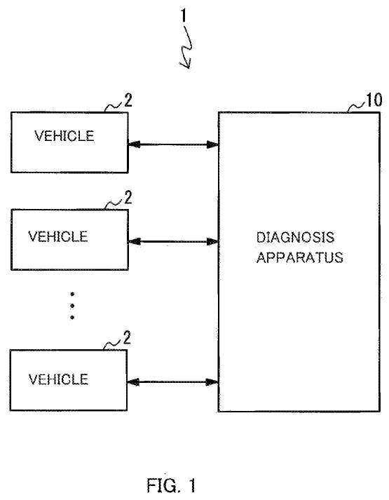

A configuration of a diagnosis apparatus according to an embodiment of the present invention will be described with reference to FIGS. 1 and 2.

FIG. 1 is a schematic diagram illustrating an outline of a diagnosis system 1. The diagnosis system 1 is a system in which a diagnosis apparatus 10 and a plurality of vehicles 2 operate in cooperation with each other to diagnose states of the vehicles 2. In the present embodiment, the vehicle 2 corresponds to an apparatus to be diagnosed, which is a diagnosis target.

The plurality of vehicles 2 are trucks, for example. The vehicles 2 are each equipped with a sensor or the like for measuring a state, and transmit measured data to the diagnosis apparatus 10 as time series data. For example, when the engine of the vehicle 2 is operating, the sensor measures a state of each unit such as a fuel injection system or an exhaust system. The sensor continuously performs measurement at predetermined intervals for a certain period of time. For example, the sensor performs measurement for 40 seconds at intervals of 12 minutes during operation of the engine of the vehicle 2.

The diagnosis apparatus 10 can perform data communication with the plurality of vehicles 2, and diagnoses states of the vehicles 2. The diagnosis apparatus 10 is a server provided in a management center, for example. The diagnosis apparatus 10 receives the time series data from each vehicle 2. The diagnosis apparatus 10 diagnoses the states of the vehicles 2 from the received time series data. The diagnosis apparatus 10 determines, based on a diagnosis result, whether a vehicle exhibits signs of a break down and needs maintenance. When it is determined that maintenance is needed, the diagnosis apparatus 10 provides a notification that prompts an administrator, a maintenance company, or the like of the vehicle 2 to perform maintenance.

The diagnosis apparatus 10 determines a vehicle 2 in which an abnormality has occurred as follows. Specifically, the diagnosis apparatus 10 acquires time series data of a short period of time (for example, 5 days) from a plurality of vehicles 2 to identify a vehicle 2 having a possibility of abnormality occurrence. Then, in order to confirm whether the abnormality actually has occurred in the specified vehicle 2, the diagnosis apparatus 10 acquires time series data of a long period of time (for example, 20 days) from said vehicle 2 again, and performs an abnormality determination. By doing this, when the vehicle 2 is identified as a vehicle 2 having a possibility of abnormality occurrence, the amount of the time series data received can be suppressed by acquiring the time series data in a short time. On the other hand, the abnormality of the vehicle 2 can be determined with high accuracy by determining the abnormality by acquiring the long-term time series data from the vehicle 2 having a possibility of abnormality occurrence.

FIG. 2 is a block diagram illustrating the configuration of the diagnosis apparatus 10. The diagnosis apparatus 10 is operated by an administrator of a management center, for example. As shown in FIG. 2, the diagnosis apparatus 10 includes a communication part 12, a storage 14, and a control part 16.

The communication part 12 communicates with the vehicles 2. The communication part 12 transmits and receives data to and from the vehicles 2. For example, the communication part 12 receives time series data indicating the states of the vehicles 2 from the vehicles 2.

The storage 14 includes a read only memory (ROM) and a random access memory (RAM), for example. The storage 14 stores various types of data and a program to be executed by the control part 16. The storage 14 stores various types of data. In the present embodiment, the storage 14 stores the time series data acquired from each of the plurality of vehicles 2.

The control part 16 is a central processing unit (CPU), for example. The control part 16 controls reception of the time series data from the vehicles 2 by executing the program stored in the storage 14. In the present embodiment, the control part 16 functions as a first data acquisition part 162, a possibility determination part 163, a second data acquisition part 164, an abnormality determination part 165, and a notification control part 166.

The first data acquisition part 162 acquires time series data for diagnosis from the vehicles 2 every predetermined time period. For example, the first data acquisition part 162 acquires the time series data from each of the plurality of vehicles 2 every month, as the predetermined time period. The first data acquisition part 162 acquires the time series data received from the vehicles 2 by the communication part 12. The first data acquisition part 162 stores the acquired time series data in the storage 14.

The time series data is data indicating an operation state of a vehicle (for example, an engine) measured in the vehicles 2. The time series data includes operation states of a combustion injection system, a valve operation system, and an exhaust system of the engine, a rotation speed of the engine, and the like, for example.

The first data acquisition part 162 acquires the time series data at predetermined intervals in each period. For example, the first data acquisition part 162 acquires the time series data from the vehicles 2 at intervals of 12 minutes. Therefore, the first data acquisition part 162 acquires the time series data a first number of times in each period.

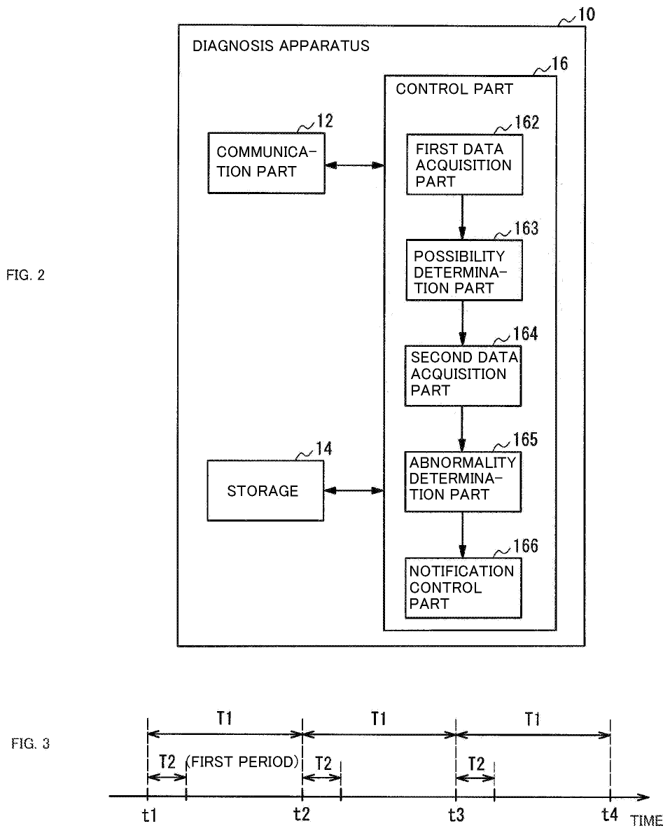

FIG. 3 is a schematic diagram illustrating a period during which the first data acquisition part 162 acquires the time series data. The first data acquisition part 162 acquires the time series data for each period T1 shown in FIG. 3. At this time, the first data acquisition part 162 acquires the time series data the first number of times in a first period T2 within the period T1. For example, the first data acquisition part 162 acquires the time series data the first number of times in the first period T2, which is a period shorter than half of the period T1. Here, the first period T2 is the first five days in each period T1. Therefore, the first data acquisition part 162 acquires the time series data the first number of times at intervals of 12 minutes for 5 days.

The possibility determination part 163 determines whether there is a possibility of abnormality occurrence in a vehicle 2. The possibility determination part 163 identifies a vehicle 2 having a possibility of abnormality occurrence from among the plurality of vehicles 2. The possibility determination part 163 determines whether there is the possibility of abnormality occurrence in the vehicle 2 during the period T1 on the basis of the time series data acquired by the first data acquisition part 162. For example, when an evaluation index of the time series data exceeds a predetermined threshold value, the possibility determination part 163 determines that there is the possibility of abnormality occurrence. The evaluation index is an index indicating the degree of abnormality of a vehicle (e.g., an engine). For example, the evaluation index is represented by a time integral of an excessive amount of data that changes over time, in the time series data, the excess amount being an amount of data exceeding a predetermined amount from when the data exceeds the predetermined amount to when the data falls below the predetermined amount.

The second data acquisition part 164 acquires the time series data from a vehicle 2 having the possibility of abnormality occurrence. In the present embodiment, when the possibility determination part 163 determines that there is the possibility of abnormality occurrence in consecutive periods T1, the second data acquisition part 164 acquires the time series data a second number of times, which is greater than the first number of times. Specifically, when it is determined that periods T1 in which the evaluation index exceeds the threshold value are continuous, the second data acquisition part 164 acquires the time series data the second number of times.

The time series data acquired by the second data acquisition part 164 is the same as the time series data acquired by the first data acquisition part 164. However, the present invention is not limited thereto, and the time series data acquired by the second data acquisition part 164 may be different from the time series data acquired by the first data acquisition part 164. The second data acquisition part 164 stores the acquired time series data in the storage 14.

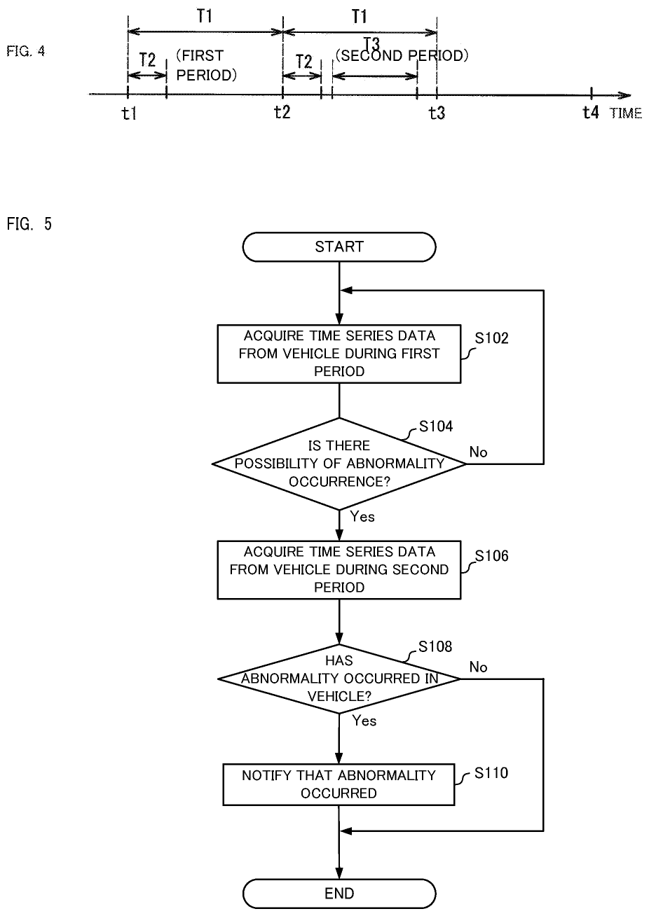

FIG. 4 is a schematic diagram illustrating a period during which the second data acquisition part 164 acquires the time series data. As shown in FIG. 4, the second data acquisition part 164 acquires the time series data in a second period T3 after the first period T2. The second data acquisition part 164 acquires the time series data the second number of times in the second period T3 which is longer than the first period T2. Here, the second period T3 is 20 days, which is more than twice the first period T2, which is 5 days. Therefore, the second data acquisition part 164 acquires the time series data the second number of times at intervals of 12 minutes for 20 days.

The abnormality determination part 165 determines whether an abnormality has occurred in the vehicle 2. The abnormality determination part 165 determines whether the abnormality has occurred in the vehicle 2 on the basis of changes in data indicated by the time series data acquired by the second data acquisition part 164. For example, the abnormality determination part 165 determines whether an abnormality has occurred in the vehicle 2 on the basis of changes in the evaluation index of the time series data. When the evaluation index shows a tendency to increase, the abnormality determination part 165 determines that the vehicle 2 has a tendency to deteriorate. The increasing tendency of the evaluation index can be determined by the inclination of the approximate line of the evaluation index, the magnitude of the accumulated value of the deviation per day, or the like, for example.

The notification control part 166 calls attention or prompts a desired operation by giving a notification. When the abnormality determination part 165 determines that an abnormality has occurred in the vehicle 2, the notification control part 166 notifies the administrator of the diagnosis apparatus 10. In addition, when the abnormality determination part 165 determines that an abnormality has occurred in the vehicle 2, the notification control part 166 may give a notification that prompts an auto repair company or the like to perform maintenance.

### <Abnormality Determination Process for a Vehicle>

An abnormality determination process for a vehicle will be described with reference to FIG. 5

FIG. 5 is a flowchart illustrating an abnormality determination process for a vehicle. First, the first data acquisition part 162 acquires time series data from each vehicle 2 during the first period T2 in each period T1 (step S102). For example, the first data acquisition part 162 acquires the time series data for the first five days of a month.

Next, on the basis of the time series data acquired from the vehicles 2 by the first data acquisition part 162, the possibility determination part 163 determines whether there is the possibility of abnormality occurrence in a vehicle 2 (step S104). For example, if the period T1 in which the evaluation index of the time series data exceeds a predetermined threshold value continues, the possibility determination part 163 determines that there is the possibility of abnormality occurrence in the vehicle 2.

When it is determined in step S104 that there is a possibility of an abnormality occurrence (Yes), the second data acquisition part 164 acquires the time series data from the vehicle 2 having the possibility of abnormality occurrence in the second period T3 which is longer than the first period T2 (step S106). For example, the second data acquisition part 164 acquires the time series data for 20 days.

Next, the abnormality determination part 165 determines whether an abnormality has actually occurred in the vehicle 2 having the possibility of abnormality occurrence, on the basis of changes in the data indicated by the time series data acquired by the second data acquisition part 164 (step S108). For example, if the evaluation index of the time series data indicates an increasing tendency, the abnormality determination part 165 determines that an abnormality has occurred in the vehicle 2.

When it is determined in step S108 that an abnormality has occurred in the vehicle 2 (Yes), the notification control part 166 notifies that an abnormality has occurred in the vehicle 2 (step S110). For example, the notification control part 166 may provide a notification that prompts to perform maintenance since the vehicle 2 exhibits signs of a break down.

### <Effects of the Present Embodiment>

The diagnosis apparatus 10 of the above-described embodiment determines whether there is the possibility of abnormality occurrence in a vehicle 2 on the basis of the time series data acquired during the period T2 (for example, five days) in the period T1. When the diagnosis apparatus 10 determines that a vehicle 2 has the possibility of abnormality occurrence, the diagnosis apparatus 10 acquires time series data only for the period T3 (for example, 20 days) from said vehicle 2, and determines whether or not an abnormality has occurred in the vehicle 2 on the basis of changes in the acquired time series data. As a result, when determining the possibility of abnormality occurrence in each vehicle 2, it is only necessary to acquire a small amount of time series data from each vehicle 2, and therefore it is possible to narrow down the vehicles 2 that are the targets of the abnormality determination while suppressing the amount of the time series data received. On the other hand, by acquiring a large amount of time series data over the period T3 from a vehicle 2 having the possibility of abnormality occurrence, it is possible to accurately perform the abnormality determination. Therefore, erroneous determinations can be prevented

The apparatus to be diagnosed, which is the diagnosis target, is the vehicle 2 in the above description, but the present invention is not limited thereto. The apparatus to be diagnosed may be an apparatus other than a vehicle.

The present disclosure is explained on the basis of the exemplary embodiments. The technical scope of the present disclosure is not limited to the scope explained in the above embodiments and it is possible to make various changes and modifications within the scope of the disclosure. For example, all or part the apparatus can be configured with any unit which is functionally or physically dispersed or integrated. Further, new exemplary embodiments generated by arbitrary combinations of them are included in the exemplary embodiments of the present disclosure. Further, effects of the new exemplary embodiments brought by the combinations also have the effects of the original exemplary embodiments.

### DESCRIPTION OF SYMBOLS

2 Vehicle
10 Diagnosis apparatus
162 First data acquisition part
163 Possibility determination part
164 Second data acquisition part
165 Abnormality determination part
T2 First period
T3 Second period

1. A diagnosis apparatus for performing data communication with an apparatus to be diagnosed, which is a diagnosis target, the diagnosis apparatus comprising:
a first data acquisition part that acquires time series data for diagnosis from the apparatus to be diagnosed every predetermined time period, the first data acquisition part acquiring the time series data a first number of times in each period;
a possibility determination part that determines whether there is a possibility of abnormality occurrence in the apparatus to be diagnosed during the predetermined time period on the basis of the time series data acquired by the first data acquisition part;
a second data acquisition part that acquires the time series data a second number of times, which is greater than the first number of times, when the possibility determination part determines that there is the possibility of abnormality occurrence in consecutive predetermined time periods; and
an abnormality determination part that determines whether an abnormality has occurred in the apparatus to be diagnosed on the basis of changes in data indicated by the time series data acquired by the second data acquisition part.

2. The diagnosis apparatus according to claim 1, wherein
the first data acquisition part acquires the time series data the first number of times in a first period within the predetermined time period, and
the second data acquisition part acquires the time series data the second number of times in a second period which is longer than the first period.

3. The diagnosis apparatus according to claim 2, wherein
the second data acquisition part acquires the time series data the second number of times in the second period which is more than twice the first period.

4. The diagnosis apparatus according to claim 1, wherein
the first data acquisition part acquires the time series data the first number of times in a first period, which is a period shorter than half of the predetermined time period.

5. The diagnosis apparatus according to claim 1, wherein
the first data acquisition part acquires, as the time series data, data indicating an operation state of the apparatus to be diagnosed.

6. The diagnosis apparatus according to claim 1, wherein
the possibility determination part determines that there is the possibility of abnormality occurrence when an evaluation index exceeds a predetermined threshold, the evaluation index being a time integral of an excess amount of data that changes over time, in the time series data, the excess amount being an amount of data exceeding a predetermined amount from when the data exceeds the predetermined amount to when the data falls below the predetermined amount.

7. The diagnosis apparatus according to claim 6, wherein
the abnormality determination part determines that an abnormality has occurred in the apparatus to be diagnosed when the evaluation index of the time series data indicates an increasing tendency.

8. The diagnosis apparatus according to claim 1, wherein
the first data acquisition part acquires the time series data from each of a plurality of the apparatuses to be diagnosed every predetermined time period, and
the second data acquisition part acquires the time series data the second number of times from one apparatus to be diagnosed being determined that there is the possibility of abnormality occurrence in consecutive predetermined periods, among the plurality of apparatuses to be diagnosed.

9. The diagnosis apparatus according to claim 1, wherein
the diagnosis apparatus diagnoses states of a plurality of vehicles, which are the apparatuses to be diagnosed, and
the first data acquisition part acquires the time series data from each of the plurality of vehicles every predetermined time period.
